(19) United States
(12) Patent Application Publication
(10) Pub. No.: US 2012/0243930 A1
(43) Pub. Date: Sep. 27, 2012

(54) CONNECTION ARRANGEMENT OF A SHAFT/HUB CONNECTION

(75) Inventors: Stefan PASTOORS, Bitterfeld-Wolfen (DE); Gerald LANGER, Buelstringen (DE)

(73) Assignee: IFA-TECHNOLOGIES GMBH, Haldensleben (DE)

(21) Appl. No.: 13/423,727

(22) Filed: Mar. 19, 2012

(30) Foreign Application Priority Data
Mar. 21, 2011 (DE) 10 2011 014 621.0

(51) Int. Cl. F16D 1/108

(52) U.S. Cl. 403/1

(57) ABSTRACT

A connection arrangement of a shaft/hub connection has a radially elastically deformable securing element that is divided in the longitudinal direction, which engages with shape fit into grooves of a shaft and a hub. The shaft has a wide groove that projects beyond the hub only in certain parts. The securing element is configured as a securing ring or bushing and is widened, at least in certain sections, in the axial direction, beyond the hub projecting into the groove of the shaft.

### CROSS REFERENCE TO RELATED APPLICATIONS

Applicants claim priority under 35 U.S.C. §119 of German Application No. 10 2011 014 621.0 filed Mar. 21, 2011, the disclosure of which is incorporated by reference.

### BACKGROUND OF THE INVENTION

1. Field of the Invention

The invention relates to a connection arrangement of a shaft/hub connection, for example the connection between a transmission shaft and a joint, having a securing element for securing the axial position of shaft and hub relative to one another.

2. The Prior Art

For axial securing of shaft/hub connections, elastically deformable securing elements are used, which are fitted into grooves of a shaft and hub in such a manner that they prevent axial displacement between shaft and hub up to a predetermined axial force. Frequently, such connection arrangements are used in articulated shafts of motor vehicles, in order to connect either components of articulated shafts with one another or the articulated shafts with a transmission shaft or differential shaft, for example. In this connection, simple assembly and disassembly, without special tools, with little expenditure of force, are important.

The simplest form of a securing element is the circlip, which is fitted into a groove of the shaft as well as a groove in the hub that is situated in the same axial position. In this connection, the cross-section of the groove of the hub is configured to be trapezoid with a slightly wider groove base, and its depth dimension is selected to be greater than the radius of the circlip, so that a tilting edge forms at the parting join of shaft and hub, which prevents the circlip from slipping out of the groove of the hub in the event that an axial force acts on it (EP 2 053 256 A2). The disadvantage of this solution consists in that it is suitable only for such shaft/hub connections that have grooves having approximately the same cross-section and are positioned precisely axially one above the other. However, it is a disadvantage that such a connection arrangement cannot be released again without destruction of the securing element, and during forceful disassembly, parts of the groove flanks of shaft and hub are also damaged.

In the case of a connection arrangement for torque-proof connection of components in the drive train of a vehicle, namely a shaft or a shaft journal with the inner hub of a joint, a securing device in the form of an engagement sleeve for holding the securing ring in its engaged position is provided in addition to the securing ring that can engage into the grooves of the shaft journal and the inner hub. This engagement sleeve is configured in U shape and has two crosspiece-like securing projections that engage into grooves additionally present in the shaft journal as well as on the outside diameter of the inner hub, and fix the shaft and the inner hub in place axially, against one another, when the securing ring has engaged into the groove of the inner hub. The securing ring is configured to be slit and possesses a rectangular cross-section. For easier disassembly, it is provided with a bevel on its face surface that faces the shaft. The engagement sleeve is set onto the connection arrangement in the radial direction and engaged on the shaft journal or the inner hub by way of detents, in the region of its securing projections (WO 2009/012767 A2). The disadvantage of this connection arrangement also consists in that it is restricted to shaft/hub connections that have grooves having approximately the same cross-section and are positioned axially precisely one on top of the other. The additional engagement sleeve requires increased production and assembly or disassembly effort. For disassembly, a special tool is required, which must be set on in a special disassembly gap provided for this purpose between shaft and hub. Furthermore, the hub must have an outer groove in every case.

In another connection arrangement between a shaft journal and a homokinetic rotational joint, a closed bracing sleeve that has at least one elastic region is provided, which sleeve engages into outer grooves of the shaft journal and of the inner joint part of the homokinetic rotational joint with its radially configured engagement tabs. The elastic configuration of the bracing sleeve is achieved by means of the recesses that run axially and/or radially and are distributed over the entire circumference (see German Patent Application Nos. DE 10 2009 016 066 A1 and DE 10 2009 020 981 A1). In this type of connection arrangement, as well, the hub must have an outer groove. Disassembly is possible with a special tool with which the engagement tabs are pressed out of the groove, whereby the disassembly force is greater than the maximal axial forces that occur in the operating state, and damage to the components is not precluded.

Furthermore, an axial attachment apparatus for a machine element is known, which prevents the exertion of radial forces or tilting moments onto the machine element to be attached even at high axial bias forces. The machine element, particularly a roller bearing ring, is attached on a shaft under axial bias, using a split ring. One side of the ring lies against the flank of a groove made in the shaft, and the other side of the ring lies against a flank of the ring recess situated in the machine element to be attached. In cross-section, the ring is configured in V shape, whereby the V-shaped part touches neither the machine element nor the shaft (See DE 82 02 674 U1).

Another axial shaft securing mechanism for a differential arrangement consists of an elastic body having a conical basic shape. This body has a plurality of elongated axial recesses along its circumference, and multiple journals directed radially inward on its face side that is smaller in diameter, which journals engage into a circumferential groove of the shaft. With its opposite face side, which has a greater diameter, the shaft securing mechanism lies against a groove flank of a spur wheel of the differential arrangement (See U.S. Pat. No. 3,527,120).

Finally, a securing apparatus for a spline shaft/hub attachment in a homokinetic joint is known, which apparatus consists of a split ring that is V-shaped in cross-section. The ring has three contact surfaces, two of which are formed by the shanks of the V-shaped cross-section, and the third of which follows the free end of the one shank of the V and runs parallel to the axis of the shaft in the assembled state. The two shanks that form the V-shaped cross-section can be moved flexibly relative to one another. The spline shaft has a circumferential groove, whose flank, facing the spline teeth, is configured to be conical, and on which the free shank of the ring lies. Its other shank that forms the V lies against an inner surface of an inner recess introduced into the hub, which surface is also configured to be conical, which recess furthermore has a wide inner surface that runs coaxially, on which the third contact surface of the ring lies. The ring furthermore lies, with its ring-shaped face surfaces, on the groove flank of the groove of the spline shaft or the inner recess of the hub, which flank runs perpendicular to the axis and lies opposite the conical contact surface, so that it prevents axial relative movement between spline shaft and hub (See U.S. Pat. No. 6,390,925 B1).

### SUMMARY OF THE INVENTION

In contrast to the above-described connection arrangements, the arrangement according to the invention has the advantage that the securing elements can be used for a greater type range of shaft/hub connections. They implement the known advantageous axial securing of a hub having an inner groove. As a result, the configuration of the external shape of the hub is not subject to any kind of restrictions that would be brought about by the provision of outer grooves for the securing element. With regard to the shaft, use of the invention is also possible with a broader range. The only prerequisite is that the shaft must have a wide groove that accommodates each securing element The wide groove can also be formed simply by a hub-side step and a component attached on the opposite side of the shaft, for example a bearing. Due to the free configuration of the groove of the shaft, it is possible to use the most varied securing elements. They must be configured like known securing elements in terms of their dimensions and properties, i.e. they must be split longitudinally so that they can be pushed onto an outside diameter of the shaft that is greater in comparison with their inside diameter. They must furthermore be elastically deformable, in order to be able to resume their initial shape in the groove of the shaft after having been pushed onto the shaft, and their inside diameter must be so much greater than the diameter of the groove base, in the assembled state, that when the hub is pushed onto the shaft, the dimension of coverage between securing element and hub is taken up by the groove of the shaft.

For the shaft/hub connection according to the invention, they must also have an additional characteristic: The securing elements must be designed, at least in certain sections, to be so wide that they project out of the hub, i.e. still cover at least a part of the width of the groove of the shaft. In this region, which is accessible from the outside, they are designed in such a manner, according to the invention, and particularly, their inside diameter is dimensioned to be so much greater than the diameter of the groove base, that in the joined state, they can be compressed with usual tools, to such an extent that the regions of the securing element that have engaged in the groove of the hub exit from this groove completely, so that the shaft/hub connection can be released without damage to any part of this connection. Conventional pliers can be used as tools for this purpose.

According to a first embodiment of the invention, the securing element consists of an axially divided bushing that projects beyond the region of the groove of the shaft covered by the hub in the assembled state. On its side facing the hub, this bushing has a collar that extends outward in the radial direction, which collar engages into the groove of the hub in the joined state. This collar can also be configured only as segments. In this way, disassembly is simplified, because only the segments of the collar have to be removed from the groove of the hub.

According to this embodiment of the invention, which is advantageous in this regard, the region of the bushing that projects beyond the hub has a greater diameter than the region that lies directly adjacent to the collar. As a result, a greater radial deformation path is available for the accessible region of the bushing during disassembly of the connection arrangement, so that when the bushing is compressed with a tool, the collar exits completely from the groove of the hub, in any case.

According to a second, particularly simple embodiment of the invention, the securing element consists of a divided spring ring in the manner of a circlip whose ends, which lie free because of the division, are angled away in the radial and axial direction. The axial angling essentially represents the widening of the securing element in the axial direction, beyond the hub, into the groove of the shaft. In this connection, of course, first each end of the securing ring must be angled away in the direction of the axis of rotation of the shaft, to such an extent that it projects out of the groove of the hub in the joined state. The axially angled part of the free ends must be configured to be at least so long that the ends that project out of the hub can be pressed together with a tool. Of course, these ends can also project beyond the entire width of the groove of the shaft, until they come up against the shaft step. However, this variant is suitable for axial securing only with restrictions when axial pressure forces act on the hub and/or shaft, because this form of axial widening of the securing element can withstand only slight axial forces.

According to a third embodiment of the invention, the securing element also consists of an axially divided bushing that projects beyond the region of the groove of the shaft covered by the hub, in the assembled state. In addition to its own radial elasticity, the bushing has multiple engagement elements that spread away from the mantle surface, on its mantle region covered by the hub. They thereby are essentially given an independent elasticity in the radial direction. In the joined state, the flared free ends of the engagement elements then engage into the groove of the hub. The engagement elements can project out of the mantle of the bushing both radially and tangentially. The advantage of these elastic regions of the bushing that act independently of one another consists in a greater configuration freedom of the grooves of shaft and hub. In particular, the groove depths are independent of one another. Furthermore, because of the projecting engagement elements, greater coverage between securing element and hub is achieved. In the case of this variant, as well, the mantle region of the bushing that projects out of the hub can have a greater diameter than the region having the engagement elements, as was described above.

According to an embodiment of the invention that is advantageous in this regard, the inside diameter of the bushing lies against the outside diameter of the groove of the shaft. The bushing is widened by being set onto the shaft, and after having sprung back lies against the outside diameter of the groove of the shaft with its inside diameter. When the hub is pushed onto the shaft, only the engagement elements are elastically deformed in the radial direction by means of the conical widening of the hub bore, and afterward they engage into the groove of the hub. Accordingly, during disassembly, only the engagement elements are pressed together at their crosspieces that project out of the hub. This variant has the advantage that no play needs to be provided between the bushing and the shaft.

According to a particularly advantageous embodiment of the invention, the width of the bushings is designed in accordance with the width of the groove of the shaft, so that the free face surface of the bushings lies adjacent to the flank of the groove. Bushings designed in this way secure the axial position between shaft and hub even during the action of pressure forces on shaft and/or hub. For easy assembly and disassembly of the bushing, of course, a certain play must be guaranteed here. The same advantage is achieved also in that the bushings are produced in a standard width, in other words independent of the width of the groove of the shaft, and the remaining interstice is filled by a simple intermediate bushing. In this way, the production effort for the securing bushings is reduced, because they can be produced in a uniform width and without close fit.

According to another advantageous embodiment of the invention, the bushings are provided with recesses. Using these means, which structure both the shape and the mass of the bushings, it is possible to not only reduce their mass, but also to influence their center of gravity in such a manner that no imbalances occur during rotation of the connection arrangement. Advantageously, the force required for deforming the bushings is furthermore reduced by the recesses, thereby facilitating disassembly of the connection arrangement.

Finally, in a particularly advantageous embodiment of the invention, the two free ends that lie opposite one another on the longitudinal division of the securing ring and of the bushings and project out under the hub can be angled away radially to the outside. These angled regions serve as an application surface for simple pliers having flat application surfaces, for disassembly of the connection arrangement. This allows greater simplification of disassembly in comparison with tools that otherwise would be applied on the circumference of the bushings, and accordingly require a curved application surface.

The following explanations relate exclusively to the configuration of the shaft and of the hub of the connection arrangement.

Thus, for example, the region of the hub that projects beyond the groove of the shaft can advantageously have a slightly greater inside diameter than the joining region in which it is connected with the shaft in a torque-proof manner. In this way, the hub can be pushed over the securing element more easily, and the groove in the shaft can be configured to be flatter.

Facilitated assembly of the components of the shaft/hub connection can be achieved by conically widening the opening of the hub that faces the groove of the shaft. This also facilitates assembly of the components of the shaft/hub connection. The joining force can be adjusted by way of the selection of the cone angle.

If the flank of the groove of the shaft, which is situated below the groove of the hub in the joined state, is configured conically in the transition to the adjacent shaft segment, a radial force component that presses the securing element in the direction of the groove of the hub occurs at this conical flank, resulting from the tensile force acting on the hub. Similar to the aforementioned European Patent No. EP 2 053 256 A2, reliable axial securing of the position of the hub is achieved, however, in contrast to the European patent, by means of a design measure on the groove flank of the shaft. The conicity of this groove flank can also be formed by means of a radius or a combination of a slant with a radius.

Means that secure the position of both parts, relative to one another, against displacement due to the pressure forces that act on the hub and/or shaft can be provided on the hub and/or shaft. As a result, the securing element itself only has to secure the axial position in one direction, namely when the shaft/hub connection is put under stress by axial tensile forces. To secure the position of hub and shaft relative to one another under axial pressure forces, it is advantageous to use known technical means for connection arrangements of articulated shafts, for example an additional securing ring that acts only in the required axial direction.

The hub of the shaft/hub connection can also have a sleeve connected with it in torque-proof manner, on the shaft side, having only one groove flank. The hub and sleeve can be structured in one part or multiple parts. The groove flank is essentially formed by a diameter reduction of the sleeve on its shaft-side opening, which is pressed against the securing element when tensile forces act on the shaft and/or hub. In this manner, hubs having a lower mass can be produced.

Further advantages and advantageous embodiments of the invention can be derived from the following description, the drawing, and the claims.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a shaft/hub connection having a securing ring,

FIG. 2 shows the securing ring in a spatial view,

FIG. 3 shows the shaft/hub connection from FIG. 1 in the assembled state,

FIG. 4 shows a section through the shaft/hub connection from FIG. 3,

FIG. 5 shows a shaft/hub connection having a collar bushing,

FIG. 6 shows the collar bushing in a spatial view,

FIG. 7 shows the shaft/hub connection from FIG. 5 in the assembled state,

FIG. 8 shows a section through the shaft/hub connection from FIG. 7,

FIG. 9 shows a section through a shaft/hub connection having a unilateral axial securing mechanism,

FIG. 10 shows a shaft/hub connection having an engagement bushing,

FIG. 11 shows the engagement bushing in a spatial view,

FIG. 12 shows the shaft/hub connection from FIG. 10 in the assembled state, and

FIG. 13 shows a section through the shaft/hub connection from FIG. 12.

### DETAILED DESCRIPTION OF THE PREFERRED EMBODIMENT

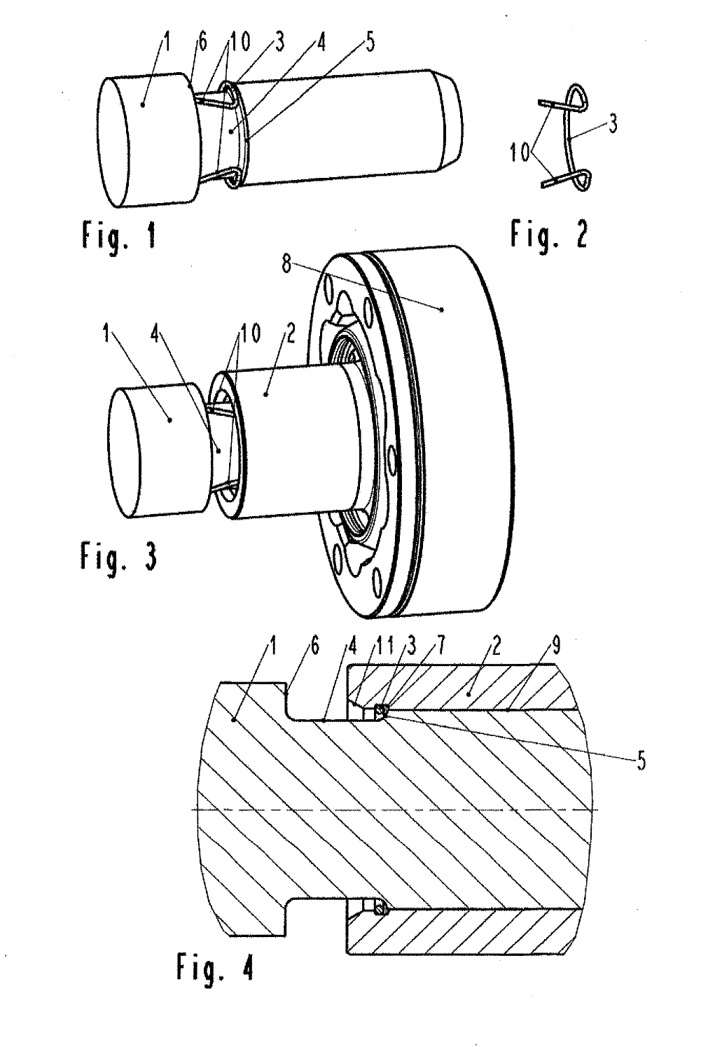

Referring now in detail to the drawings, in FIGS. 1 to 4, a connection arrangement between a shaft 1 and a hub 2, by means of a securing ring 3, is shown. The shaft 1 has a wide groove 4 having a groove flank 5 structured to be conical on the hub side, and a groove flank 6 that lies opposite and runs perpendicular to the axis. A narrow inner groove 7 is worked into the hub 2, whose width is slightly greater than the diameter of the securing ring 3, and the depth of which approximately corresponds to the radius of the ring. FIG. 3 shows the hub 2 which is connected with a joint 8 in a torque-proof manner. In FIGS. 1 and 4, representation of this joint 8 was refrained from, for reasons of a clearer illustration. Axially following the conical groove flank 5, the shaft 1 has an outer longitudinal profile, and the hub 2 has an inner longitudinal profile following its inner groove 7. In the joined state, the outer and inner longitudinal profile engage into one another, with shape fit, to produce a torque-proof connection 9.

The securing ring 3 is axially divided, whereby the ends are continued in the axial direction at a distance from one another, so that they project out of the ring plane as free ends 10. The angling has taken place, in the present example, not precisely in the axial direction but rather at an angle greater than 90°, in order to avoid tilting of the securing ring 3 when the hub 2 is pushed on. At first, however, the free ends 10 are angled away approximately by the amount of the groove depth of the hub 2, in the radial direction, before being angled away axially, so that they would lie against the circumference of an imaginary circle that has a smaller diameter than the inside diameter of the securing ring 3. As a result, the free ends 10 can exit from the inner groove 7 of the hub 2 in the joined state, and can extend along the wide groove 4 of the shaft 1. The length of the free ends 10 is selected to be such, in the present example, that they project beyond the entire width of the groove 4, in other words lie against the opposite, vertical groove flank 6.

From FIGS. 1 and 4, it is evident that the inside diameter of the securing ring 3, in the assembled state, is greater than the outside diameter of the groove 4 of the shaft 1 and smaller than the outside diameter of the shaft 1. Because of its division, it can easily be pushed over the greater shaft diameter, and engages in the wide groove 4 of the shaft 1 directly behind the conical groove flank 5. The free ends 10 lie against the groove base and make contact with the vertical groove flank 6 that lies opposite. The face surface of the hub 2 that faces the groove 4 is provided with an introduction cone 11 that presses the securing ring 3 into the wide groove 4 when it is pushed onto the shaft 1. As soon as the inner groove 7 of the hub 2 is situated above the wide groove 4 of the shaft 1, the securing ring 3 snaps into the inner groove 7 of the hub 2. In the case of tensile forces acting on the shaft 1 and/or the hub 2, their axial position relative to one another is secured in that these tensile forces press the securing ring 3 against the conical groove flank 5 of the shaft 1. By means of the conical configuration of this groove flank 5, a component of the tensile forces acts outward in the radial direction, so that the securing ring 3 is pressed into the groove base of the inner groove 7 of the hub 2.

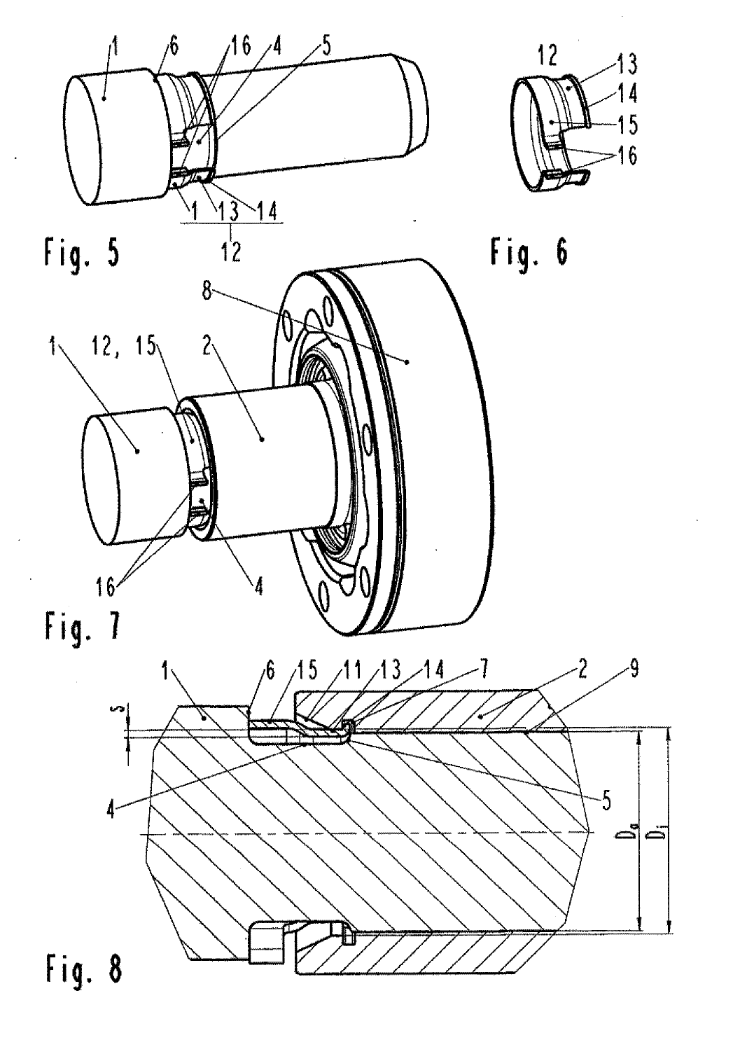

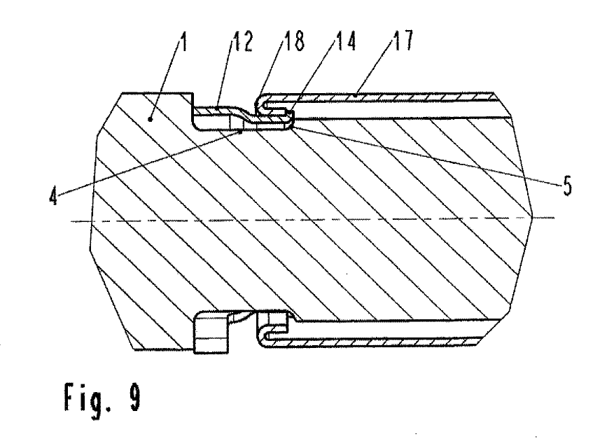

In another embodiment, a connection arrangement between the shaft 1 and the hub 2 by means of a collar bushing 12 is shown in FIGS. 5 to 8. The dimensions of shaft 1 and hub 2 as well as of the groove 4 of the shaft 1 are the same as those of the components shown in FIGS. 1 to 4. In the present example, the hub 2 has a greater inside diameter Di between introduction cone 11 and torque-proof connection 9 than in the region of the torque-proof connection. The elastically deformable securing element consists, in this exemplary embodiment, of an axially slit collar bushing 12 that has three functional regions having different diameters, which regions lie axially next to one another. A first functional region, namely a contact region 13, lies directly against the enlarged inside diameter Di of the hub 2 in the joined state. For reliable axial securing, the outside diameter Da of the shaft 1 must be greater than the inside diameter Di of the hub 2, which has been reduced by twice the thickness s of the collar bushing 12 in its contact region 13.

The second functional region of the collar bushing 12 is formed by a collar 14 disposed on the face side facing the hub 2, the outside diameter of which collar is greater than the outside diameter of the shaft 1, so that in the joined state, it projects into the inner groove 7 of the hub 2.

A third functional region follows the contact region 13 on the side of this region that lies opposite the collar 14. This functional region, referred to as an assembly region 15, projects out of the hub 2 into the region of the groove 4 of the shaft 1 in the joined state, and has a greater diameter than the contact region 13. In the present example, the width of the assembly region 15 is selected to be such that it reaches all the way to the vertical groove flank 6 with its free face surface, whereby, however, the collar bushing 12 can still easily be inserted into the groove 4 of the shaft 1. A collar bushing 12 dimensioned in this manner can absorb both axial tensile and pressure forces, so that it guarantees securing of the axial position of shaft 1 and hub 2 relative to one another in both axial directions. In this connection, the conical groove flank 5 acts in a similar manner as described in the explanations regarding the securing ring 3, when tensile forces on the shaft 1 and/or hub 2 occur, namely that it transfers a radial component of the tensile force to the collar bushing 12, so that the latter is pressed against the inner surface with its cylindrical contact region 13, and the collar 14 is pressed into the inner groove of the hub 2.

The free ends of the collar bushing 12, which lie opposite one another at a distance as the result of the longitudinal slit, have a pressure surface 16 angled away radially to the outside, in the assembly region 15. Because the assembly region 15 is accessible from the outside in the joined state, a pliers can be applied to these pressure surfaces, in order to press the collar bushing together to such an extent that the collar 14 slips out of the inner groove 7 of the hub 2. As a result, the hub 2 can be pulled off the shaft 1 without being destroyed. Because of this function, further dimensions of the collar bushing 12 are determined, in terms of design, for example the ratio of inside diameter of the collar bushing 12 in the contact region 13 and outside diameter of the groove 4 of the shaft 1. The latter must be smaller by at least twice the amount of the collar 14 that projects beyond the outside diameter of the collar bushing 12 in the contact region 13, so that the collar 14 can be completely pressed out of the inner groove 7 of the hub 2.

For assembly, the collar bushing 12 is pushed onto the shaft 1 until it engages into the groove 4 of shaft 1. When the hub 2 is pushed on, its introduction cone 11 presses the collar bushing 12 into the groove 4, its free ends come closer to one another and the collar bushing 12 is elastically deformed to a smaller diameter. As soon as the inner groove 7 of the hub 2 is situated above the groove 4, the collar bushing 12 springs back into its starting position, and the collar 14 engages into the inner groove 7 of the hub 2.

FIG. 9 shows a section through another variant of a shaft/hub connection, in which the hub, not shown in any detail here, is connected with a sleeve 17 in torque-proof manner, and other means, also not shown in any detail here, for securing the position between shaft 1 and hub for taking up axial pressure forces are provided or already present, in terms of the design. The generally required inner groove of the hub, into which the securing element engages in the joined state, is formed here only by an inner beading 18 on the face surface of the sleeve 17 that faces the groove 4 of the shaft 1. This inner beading 18, in the case of axial tensile forces, offers not only the groove flank for the contact point of the collar 14 but also the contact surface for the contact region 13 of the collar bushing 12. This variant has the advantage that the part of the hub that guarantees axial securing is simple to produce and also can be structured to be very light, thereby making it possible to reduce the mass of the shaft/hub connection as a whole. A further advantage of this two-part configuration of the hub consists in that different configurations and applications of shaft/hub connections can be implemented in simple manner, merely by means of variation of the design of sleeve 17, without having to change the part of the hub that is connected with the component that follows in the torque transfer chain.

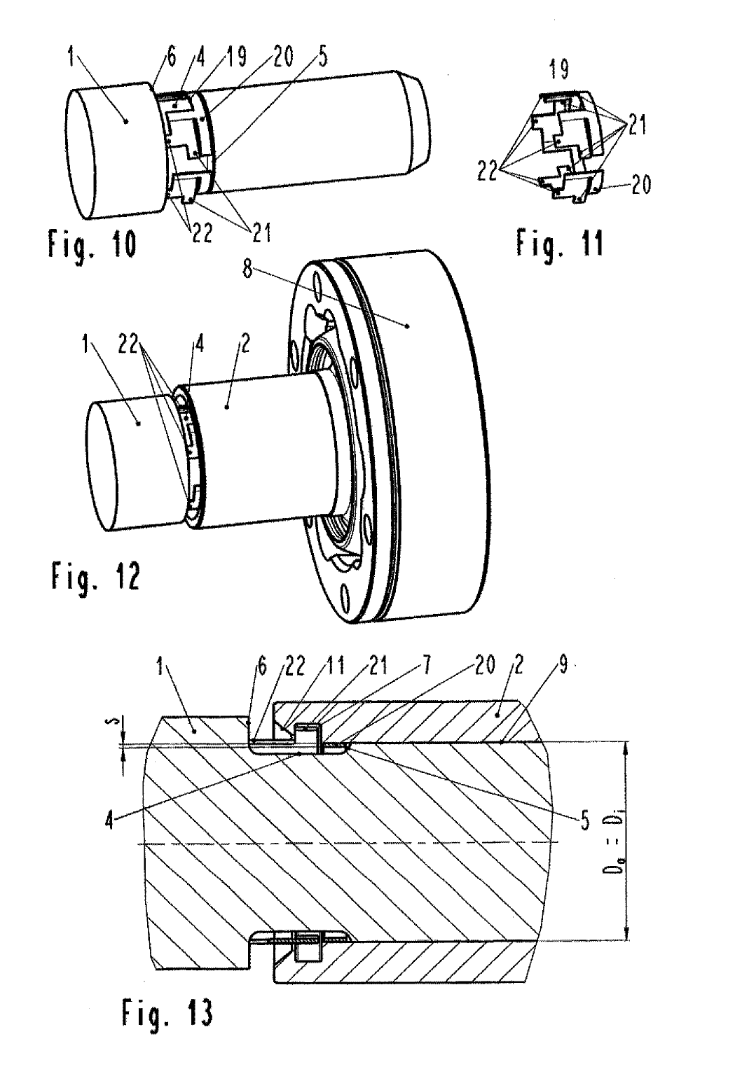

A third embodiment of a connection arrangement between the shaft 1 and the hub 2 is shown in FIGS. 10 to 13. The dimensions of shaft 1 and hub 2 as well as the groove 4 of the shaft 1 are the same as those of the components shown in FIG. 1 to 8. In contrast to the two previous embodiments, however, the inner groove 7 is configured to be clearly wider and deeper than those of the hubs 2 shown in these exemplary embodiments.

The elastically deformable securing element consists, in this embodiment, of an axially slit engagement bushing 19 having free ends spaced apart from one another, which also has three functional regions. A first region is formed by the cylindrical mantle region 20 interrupted only by the slit, which region extends axially from the face side facing the hub 2, in the direction of the groove 4 of the shaft 1. In the joined state, the engagement bushing 19 lies against the inner surface of the hub 2 with this region, specifically in the region of the inner surface that is situated between the conical groove flank 5 and the inner groove 7 of the hub 2. As has already been described for the example of the collar bushing 12, the outside diameter Da of the shaft 1 must be greater than the inside diameter Di of the hub 2, reduced by twice the thickness s of the engagement bushing 19 in its cylindrical mantle region 20, in order to achieve reliable axial securing. This also holds true if, as in the present example, Da and Di are the same.

The second functional region is formed from the circumference region of the engagement bushing 19 that follows the cylindrical mantle region 20 in the axial direction. From this, engagement elements 21 having a width that corresponds to the width of the inner groove 7 of the hub 2 in the present example are tangentially spread away.

The third functional region of the engagement bushing 19 is formed by crosspieces 22 that extend from the engagement elements 21, in the axial direction, over the remaining width of the groove 4 of the shaft 1, so that in the joined state, they exit from the hub 2 and project all the way to the vertical groove flank 6. The total width of the engagement bushing 19, just like the width of the collar bushing 12, must be dimensioned in such a manner that the engagement bushing 19 can still be easily inserted into the groove 4 of the shaft 1. Because the crosspieces 22 lie against the vertical groove flank 6, the engagement bushing 19 is suitable for absorbing both axial tensile and pressure forces, so that it guarantees securing of the axial position of shaft 1 and hub 2 relative to one another in both axial directions. In this connection, the conical groove flank 5 acts in the same manner when tensile forces on the shaft 1 and/or groove 2 occur as described in the explanations concerning the securing ring 3 and the collar bushing 12, namely that it transfer a radial component of the tensile force to the engagement bushing 19, so that the latter is pressed against the inner surface of the hub 2 with its cylindrical mantle region 20.

The crosspieces 22 that project out of the hub 2 are freely accessible for application of a tool. By radially pressing these crosspieces 22 together, the detents 21 are pressed out of the inner groove 7 of the hub 2, so that the hub 2 can be pulled off the shaft 1 without damage to part of the connection arrangement.

Assembly of the engagement bushing 19 takes place in the same manner as that of the collar bushing 12.

Accordingly, while only a few embodiments of the present invention have been shown and described, it is obvious that many changes and modifications may be made thereunto without departing from the spirit and scope of the invention.

### REFERENCE NUMBER LIST

1 shaft
2 hub
3 securing ring
4 wide groove
5 conical groove flank
6 vertical groove flank
7 inner groove
8 joint
9 torque-proof connection
10 free ends
11 introduction cone
12 collar bushing
13 contact region
14 collar
15 assembly region
16 pressure surface
17 sleeve
18 inner beading
19 engagement bushing
20 cylindrical mantle region
21 engagement element
22 crosspiece
Di inside diameter of the hub
Da outside diameter of the shaft
s thickness of the collar bushing

What is claimed is:

1. A connection arrangement for a shaft/hub connection for securing an axial position of a shaft and hub relative to one another in a torque-proof manner, comprising:
a shaft having a groove widened in an axial direction;
a hub having a groove; and
a radially elastically deformable securing element that is divided in the longitudinal direction and engages with shape fit into the grooves of the shaft and the hub, the securing element consisting of an axially divided bushing having a collar that extends outward in a radial direction, on its face side facing the hub, said collar engaging into the groove of the hub in a joined state of the hub and shaft,
wherein the groove of the shaft is widened in the axial direction, beyond the hub,
wherein a flank of the groove of the shaft, which is situated below the groove of the hub in the joined state, is conically widened in a direction of a transition to an adjacent shaft section, and
wherein the securing element is widened, at least in certain sections, proceeding from its side surface that faces away from the hub, in the axial direction, beyond the hub, projecting into the groove of the shaft.

2. The connection arrangement according to claim 1, wherein the collar is configured only in the manner of segments.

3. The connection arrangement according to claim 1, wherein a region of the bushing that projects beyond the hub has a greater diameter than a region directly adjacent to the collar.

4. The connection arrangement according to claim 1, wherein free ends of the bushing, which project under the hub in the joined state, are angled away radially to an outside.

5. The connection arrangement according to claim 1, wherein the bushing has recesses in its mantle region.

6. A connection arrangement for a shaft/hub connection for securing an axial position of a shaft and hub relative to one another in a torque-proof manner, comprising:
a shaft having a groove widened in the axial direction;
a hub having a groove; and
a radially elastically deformable securing element that engages into the grooves of the shaft and hub with shape fit and which is divided in the longitudinal direction, said securing element consisting of a securing ring having exposed ends that are extended by means of radial and axial angling away beyond the hub and which project into the groove of the shaft,
wherein the groove of the shaft is widened in the axial direction beyond the hub, and
wherein a flank of the groove of the shaft, which is situated below the groove of the hub in the joined state, is conically widened in a direction of a transition to an adjacent shaft section.

7. The connection arrangement according to claim 6, wherein the securing ring lies only against the groove flank that faces the hub, and wherein means are provided on the shaft and/or hub, said means securing the position of the shaft and hub relative to one another against displacement due to pressure forces that act on the shaft and/or the hub.

8. The connection arrangement according to claim 6, wherein the axial angled parts of the free ends of the securing ring project beyond an entire width of the groove of the shaft.

9. The connection arrangement according to claim 6, wherein the free ends of the securing ring, which project underneath the hub in the joined state, are angled away radially to an outside.

10. A connection arrangement for a shaft/hub connection for securing an axial position of a shaft and hub relative to one another in a torque-proof manner, comprising:
a shaft having a groove widened in an axial direction;
a hub having a groove; and
a radially elastically deformable securing element that engages the grooves of the shaft and hub with shape fit and which is divided in the longitudinal direction, said securing element consisting of an axially divided bushing that has multiple engagement elements in its mantle region, and which is still situated under the hub in the joined state, said elements spreading away and engaging into the groove of the hub in the joined state,
wherein the groove of the shaft is widened in the axial direction beyond the hub,
wherein a flank of the groove of the shaft, which is situated below the groove of the hub in the joined state, is conically widened in a direction of a transition to an adjacent shaft section, and
wherein the securing element is widened, at least in certain sections, proceeding from its side surface that faces away from the hub, in the axial direction, beyond the hub, projecting into the groove of the shaft.

11. The connection arrangement according to claim 10, wherein in the joined state, the bushing lies against an outside diameter of the groove of the shaft with its inside diameter, and wherein the mantle region of the bushing that projects beyond the hub in the axial direction is formed by crosspieces that are connected with the engagement elements.

12. The connection arrangement according to claim 10, wherein a width of the bushing is equal to a width of the groove of the shaft.

13. The connection arrangement according to claim 10, wherein free ends of the bushing, which project under the hub in the joined state, are angled away radially to the outside.

14. The connection arrangement according to claim 10, wherein the bushing has recesses in its mantle region.
